(19) United States
(12) Patent Application Publication
(10) Pub. No.: US 2024/0208312 A1
(43) Pub. Date: Jun. 27, 2024

(54) Car Sun Shelter, Car Luggage Rack and Control Method of the Car Sun Shelter

(71) Applicant: Shenzhen Geruier Technology Co., Ltd., Shenzhen City (CN)

(72) Inventors: Jingru Li, Shenzhen (CN); Lei Li, Shenzhen (CN)

(21) Appl. No.: 18/088,587

(22) Filed: Dec. 25, 2022

(51) Int. Cl. B60J 11/04; B60J 3/02; B60J 11/02

(52) U.S. Cl. CPC B60J 11/04; B60J 3/0256; B60J 3/026; B60J 11/02

(57) ABSTRACT

A car sun shelter includes a component carrier, a shielding component positioned on the component carrier and driving component for driving the shielding component to be fully folded and unfolded to form sun shield at the predetermined position. The car sun shelter can form a sun shield at the predetermined position of the vehicle through the driving component, in order to reduce direct sunlight to vehicles and reduce the temperature inside the car during outdoor use, prolong the service life of leather, wires and plastic products in the vehicle, and avoid the release of harmful gases from car seat and decorations inside the car at high temperatures, which will affect the health of drivers and passengers.

### FIELD OF THE INVENTION

This invention relates to the technical field of car accessories, in particular to the car sun shelter and control method of the car sun shelter.

### BACKGROUND OF THE INVENTION

Cars have become one of the main means of transportation for people's daily travel, which bringing great convenience to us. But with the concentration of urbanized population, the parking spaces in the city are difficult to meet the demand, which also brings about the problem of difficult parking. In particular, the number of underground garages is limited, resulting in a large number of vehicles that can only be parked outdoors.

Due to the strong sunlight in summer, the temperature inside the vehicles parked outdoors can become too high. On the one hand, it will reduce the comfort of the drivers and passengers when entering into the car. On the other hand, the increase of the temperature in the car will accelerate the aging of the leather, wires and plastic products in the car. In addition, under high temperature, car seat and decorations inside the car may release gases that are harmful to the people, which will cause harm to the health of drivers and passengers.

### SUMMARY OF THE DISCLOSURE

The purpose of the present invention is to provide the car sun shelter, car luggage rack and control method of the car sun shelter, so as to solve the technical problems remained in the background art above.

In order to achieve the above object, firstly, the present invention provides the car sun shelter, comprising component carrier; shielding component installed on the component carrier; and driving component for driving the shielding component to be fully folded and unfolded to form the sun shield at predetermined position.

The present invention of car sun shelter of can form sun shield at the predetermined position of the vehicle through the driving component, in order to reduce direct sunlight to vehicles and reduce the temperature inside the car during outdoor use, prolong the service life of leather, wires and plastic products in the vehicle, and avoid the release of harmful gases from car seat and decorations inside the car at high temperatures, which will affect the health of drivers and passengers. Further, the photovoltaic panel and/or display screen is provided on the outer surface of the component carrier. Further, the component carrier includes the shell. The shell further includes the shell wall and an accommodating cavity formed by the shell wall. At least one side wall of the shell is provided with the second channel/second opening connected to the accommodating cavity.

The driving component includes: telescopic part, connected with one end of the shielding component. The telescopic part comprises the first movable rod and second movable rod, one end of the first movable rod is connected with one end of the shielding component and one end of the second movable rod is hinged with the other end of the first movable rod; driving part, includes a motor; The connecting shaft is provided on the end of the second movable rod away from the hinge joint, the connecting shaft is sleeved with the first gear; The second gear meshed with the first gear is sleeved on the output shaft of the motor; and winding part, is connected with the other end of the shielding component, used for winding the shielding component.

The driving component includes telescopic part, consists of the first movable rod and second movable rod; one end of the first movable rod is connected with one end of the shielding component, one end of the second movable rod is hinged with the other end of the first movable rod; the connecting block is hinged on the end of the first movable rod away from the hinged connection with the second movable rod, and the movable plate capable of opening or closing the second channel/second opening is connected to the connecting block; driving part, includes a motor. The connecting shaft is provided on the end of the second movable rod away from the hinge joint, the connecting shaft is sleeved with the first gear; The second gear meshed with the first gear is sleeved on the output shaft of the motor; winding part, is connected with the other end of the shielding component, used for rolling the shielding component. One end of the shielding component is fixedly connected to the movable plate, and the other end is fixedly connected to the winding part.

Further, the winding part includes the winding drum, which is rotatably connected to the inner wall of the shell through the winding sleeve; The winding sleeve is connected to the winding drum through the flat scroll spring provided inside, and the winding drum is connected to one end of the shielding component.

Further, the shell consists of the top arc cover plate, bottom connecting plate, and mounting plate arranged on both sides between the top arc cover plate and the bottom connecting plate; the gap between the top arc cover plate and the bottom connecting plate is defined as the second channel/second opening.

Further, the car sun shelter further includes an mounting structure positioned at the bottom of the shell, and the mounting structure includes: fixed clamp, which has an accommodating space inside; first opening, which is provided on the side wall of the fixed clamp and connected to the accommodating space; nut, placed in the aforementioned accommodating space; movable clamp, which has the first channel penetrating through its two side walls; connecting rod, capable of entering into the accommodating space through the first channel/first opening, which has threads mating with the nut on one end located within the accommodating space; and limiting member, which is sleeved on the other end of the connecting rod, abutted with the movable clamp.

Further, the component carrier includes the frame, which comprises the wall portion and accommodating space formed by the wall portion; The wall portion is provided with at least one opening connected to the accommodating space. The shielding component includes the telescopic frame and shield; the telescopic frame is arranged on the frame, which can be fully folded or unfolded; The shield is arranged on the telescopic frame, which can be fully folded or unfolded along with the telescopic frame. The driving component can be used for driving the telescopic frame to be fully folded or unfolded.

Further, the car sun shelter including an angle adjustment mechanism for adjusting the inclination of the telescopic frame, the angle adjustment mechanism comprises any one of the following structures: (a) The angle adjustment mechanism includes the linear limiting groove, at least one notch and connecting rod; In which, at least one of the notch is located on the side wall of the linear limiting groove in the width direction; One end of the connecting rod is hinged with the mounting seat, and the other end is provided with the sliding block; The sliding block is located in the linear limit groove and can be clamped in the notch; (b) The angle adjustment mechanism includes the linear limiting groove, connecting rod and telescopic mechanism; In which, one end of the connecting rod is hinged with the mounting seat, and the other end is provided with the sliding block; The sliding block is located in the linear limiting groove and can slide back and forth along the length direction of the linear limiting groove; The telescopic direction of the telescopic mechanism is parallel to the linear limiting groove, one end of the telescopic mechanism is fixedly connected to the sliding block, and the other end is fixedly connected to the frame.

Further, the notch is formed by extending downward from the lower side wall of the linear limiting groove and further extending toward the mounting seat. Further, the telescopic frame comprises a plurality of scissor-like elements that are linked and hinged with each other, and the scissor-like elements include scissor arm groups, two sets of which are set opposite to each other; the scissor arm groups include the first scissor arms and second scissor arms, which are crossed and hinged with each other; and articulated arm, which is used to connect two sets of the scissor arm groups, as the carrier for installing the shield, and as the hinge shaft for realizing the hinge connection between the scissor-like elements, between the first scissor arms and second scissor arms.

Further, the shield comprises solar power generation panel or solar film. The driving component includes a motor; gears, which are coaxially connected to the output shaft of the motor and fixedly connected to the output shaft at least in the circumferential direction of the output shaft; gear rack, which meshes with the gears, hinged with the first scissor arms or the second scissor arms of the scissor-like elements connected to the frame; mounting seat, which is hinged with the frame, provided with the linear chute; the hinge column capable of sliding back and forth along the trajectory of the linear chute is provided within the linear chute. The hinge column is fixedly connected with the gear rack, the first scissor arms or the second scissor arms are hinged with the mounting seat through the hinge column. The gears can be driven to rotate by the motor, in order to drive the gear rack to perform linear motion, then the scissor-like elements can be driven to perform scissor motion, so that the telescopic frame can be driven to be fully folded or unfolded.

Further, the car sun shelter comprises a controller; airbag, which is connected to the side of the frame facing to the telescopic frame and located below the telescopic frame; inflation mechanism, electrically connected with the controller, for inflating the airbag; water pressure sensor, which is used to detect the water pressure and transmit the signal of water pressure to the controller when the water pressure reaches the set threshold; and pressure sensor, electrically connected with the controller, which is used for detecting the pressure in the airbag.

Further, the openings are provided above and below the frame and the wall portion of the frame can be sealing connected with the installation objects to form the escape space with the opening facing upwards and the other directions closed. The highest plane formed by the fully unfolded telescopic frame is lower than the upper end surface of the frame.

Further, the bottom center of the frame is fixedly provided with the disc and second motor for driving the disc to rotate. In order to achieve the above object, secondly, the present invention provides the car luggage rack, consist of the luggage frame and the car sun shelter; The car sun shelter can be arranged on both ends of the luggage frame, the second channel/second opening connected to the accommodating cavity is provided on one side wall of the shell of the car sun shelter.

The car luggage rack of the present invention not only has the basic function of carrying articles, but also has the extensive function of sun shelters. At the same time, this luggage rack keeps the overall structure simple and compact under the premise of having multiple functions.

In order to achieve the above object, thirdly, the present invention provides the control method of the car sun shelter when the pressure value obtained by the water pressure sensor reaches the threshold and lasts for a predetermined period of time, it is should be used as an effective signal for the controller to control the inflation mechanism to inflate the airbag. Then the airbag and the telescopic frame should be opened, and telescopic frame should be driven to press down the airbag.

The control method of the present invention enables the airbag to be opened when the vehicles fall into the water, and provides upward buoyancy for the vehicles, in order to prevent the vehicles from sinking and protect the life and property safety of the drivers and passengers in the vehicles.

Other features and advantages of the present invention are described in detail in the following section of specific implementation.

### BRIEF DESCRIPTION OF THE DRAWINGS

FIG. 1 is the schematic view of an embodiment of the car sun shelter;

FIG. 2 is the partial schematic view of FIG. 1;

FIG. 3 is the schematic view of an embodiment of the driving component;

FIG. 4 is the schematic view of the winding drum and the winding sleeve;

FIG. 5 is the schematic side view of FIG. 4;

FIG. 6 is the schematic view that the mounting structure installed at the bottom of the shell;

FIG. 7 is the schematic view of an embodiment of the mounting structure;

FIG. 8 is the internal schematic view of the mounting structure;

FIG. 9 is the schematic view of an embodiment of the car luggage rack;

FIG. 10 is the schematic view of another embodiment of the car sun shelter;

FIG. 11 is the partial schematic view of the telescopic frame;

FIG. 12 is the partial schematic view of the driving component;

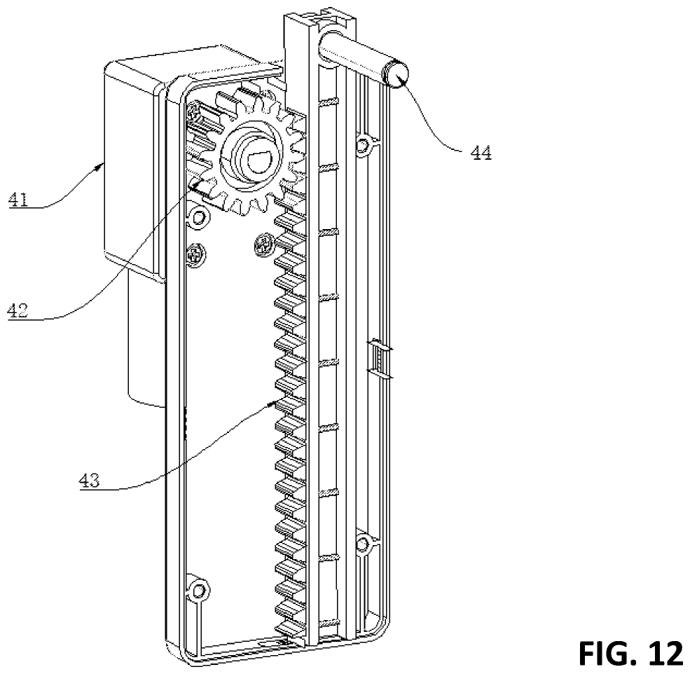

FIG. 13 is the partial schematic view of the car sun shelter;

FIG. 14 is the internal schematic view of FIG. 13;

FIG. 15 is the schematic view of an embodiment of the linear limiting groove and the notch;

FIG. 16 is the schematic view of another embodiment of the linear limiting groove and the notch;

FIG. 17 is the schematic view of another embodiment of the linear limiting groove and the notch;

FIG. 18 is the partial schematic view of an embodiment of the telescopic mechanism;

FIG. 19 is the schematic view of an embodiment of the frame;

FIG. 20 is the schematic view of an embodiment of the installation method of blower;

FIG. 21 is the schematic view of the installation method of the air inlet;

FIG. 22 is the schematic view of the airbag and the telescopic frame in the fully unfolded state; and

FIG. 23 is the schematic view of an embodiment of the airbag.

### DETAILED DESCRIPTION OF THE PREFERRED EMBODIMENTS

Hereinafter, embodiments of the present invention will be described in detail with reference to the accompanying drawings. Therefore, the present invention should not be construed as being limited to the description of the following embodiments.

In the present invention, unless otherwise stated, the use of orientation words such as “upper, lower” generally refers to the orientation under state of use. “Inside and outside” means inside and outside relative to the contours of each component itself.

It should be noted that the terms “first”, “second” and the like in the description and claims of the present invention and the above drawings are used to distinguish similar objects, which are not necessarily used to describe a specific order or sequence. It is to be understood that the data so used are interchangeable under appropriate circumstances in order to describe the embodiments of the invention herein.

Furthermore, the terms “comprising” and “having” and any variations thereof, are intended to cover non-exclusive inclusion, for example, a process, method, system, product or device comprising a series of steps or units is not necessarily limited to those steps or units explicitly listed, but may include other steps or units not expressly listed or inherent to these process, method, product or apparatus.

In addition, the terms “In an embodiment”, “Embodiment 1”, “an example”, etc. means that a particular feature, structure, material or characteristic described in connection with the embodiment or example is included in at least one embodiment of the present invention. Thus, appearances of the these phrases in various places throughout this invention are not necessarily all referring to the same embodiment or example.

Firstly, the present invention provides the car sun shelter, which includes the component carrier, shielding component 82 and driving component. Wherein the shielding component 82 is installed on the component carrier. The driving component is used for driving the shielding component to be fully folded and unfolded, so as to form the sun shield at predetermined position.

### Embodiment 1

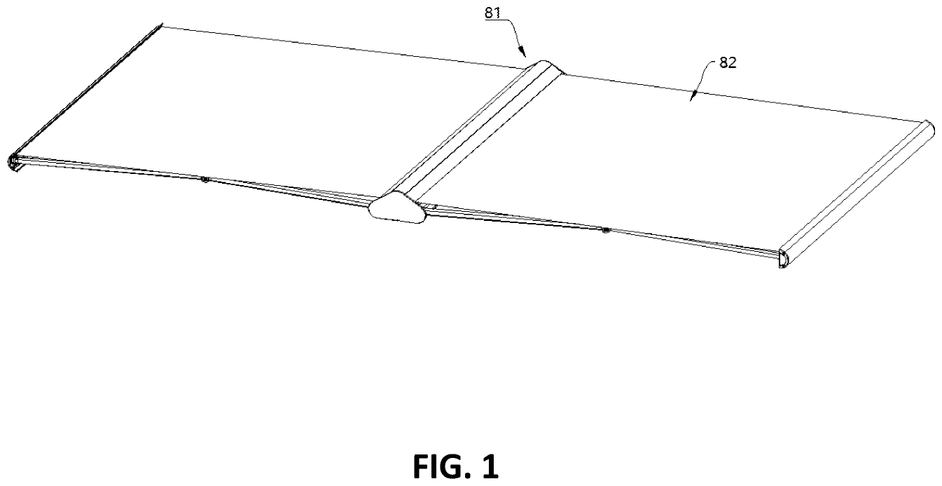

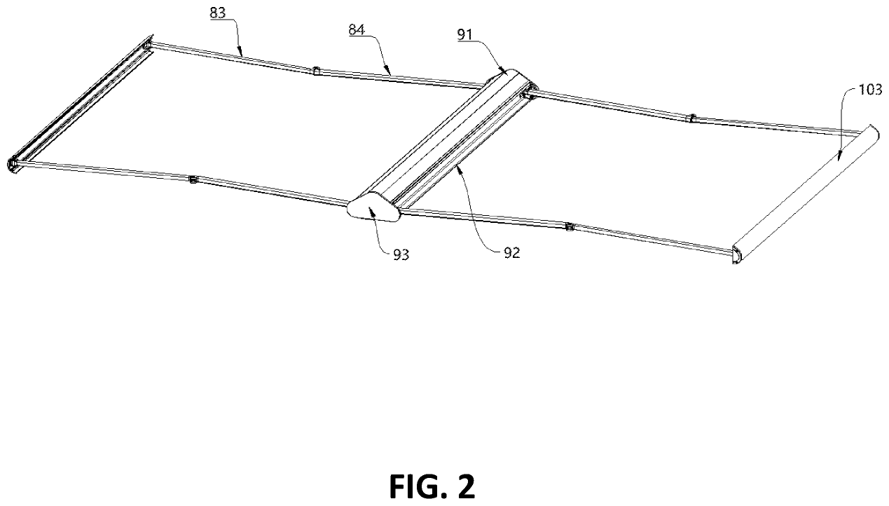

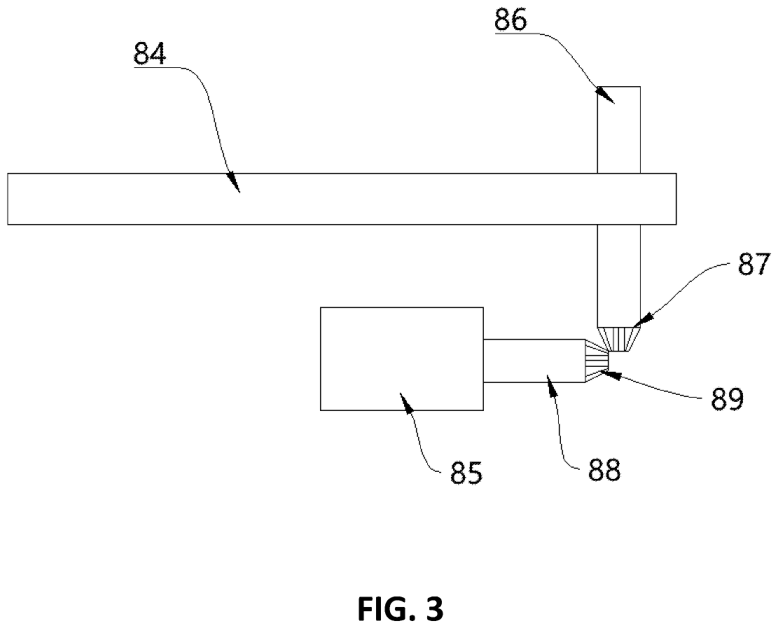

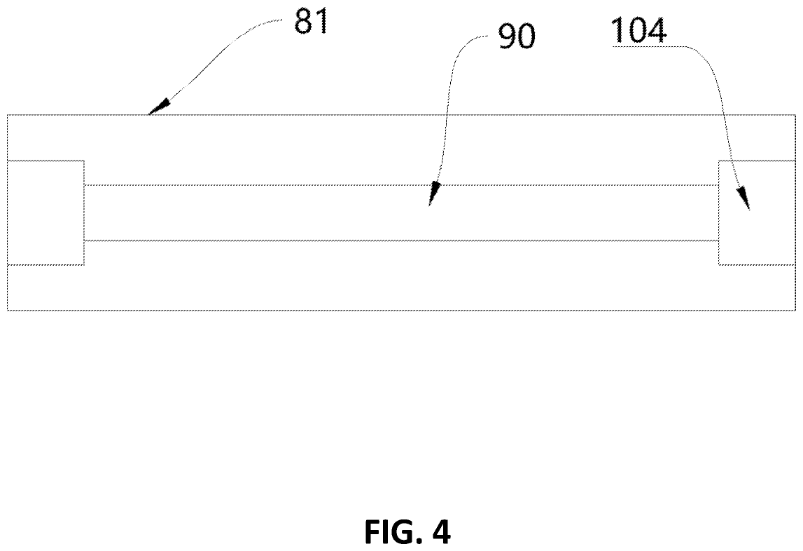

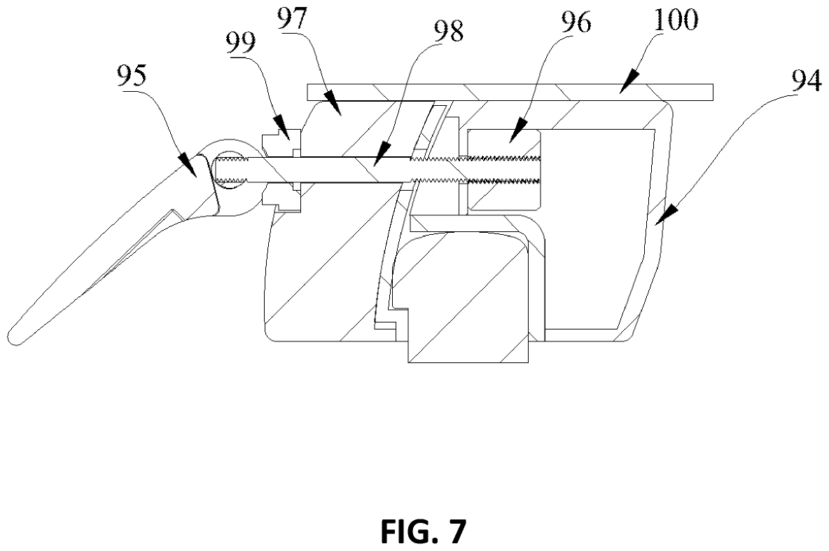

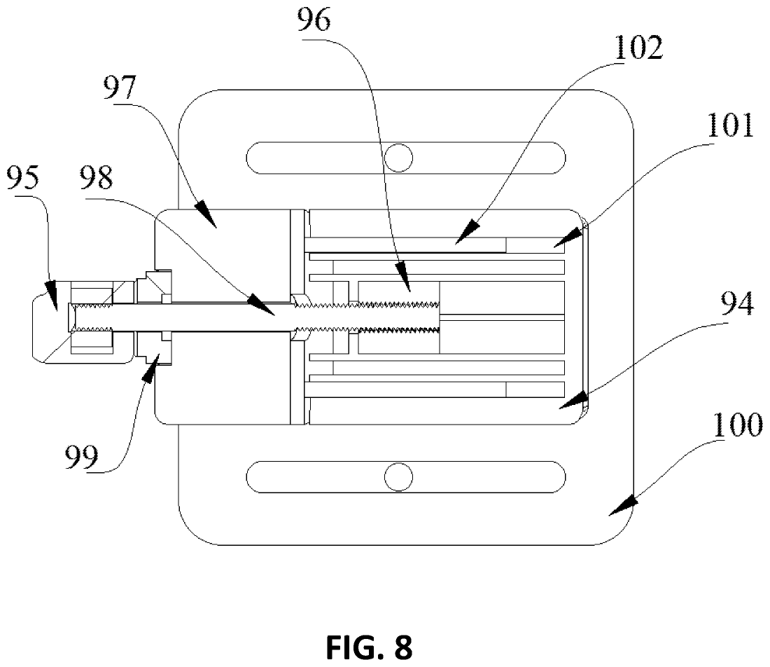

As shown in FIGS. 1-8, the component carrier includes the shell 81. The shell 81 further includes the shell wall and an accommodating cavity formed by the shell wall; At least one side wall of the shell 81 is provided with the second channel/second opening connected to the accommodating cavity; The driving component is used to drive the shielding component 82 to be folded and unfold, so as to form the sun shield at predetermined position.

In order to achieve “self-sufficiency” of electrical energy, photovoltaic panels and/or photovoltaic films could be provided on the outer surface of the shell 81. The electric energy for folding and unfolding of the car sun shelter could be provided by photovoltaic panels and/or photovoltaic films. Further, the battery can be provided to store the electrical energy generated by the photovoltaic panel and/or the photovoltaic films. The electrical energy generated by photovoltaic panels and/or photovoltaic films can be used to not only car sun shelters but also cars.

The shielding component 82 accommodated in the shell 81 can be fully unfolded through the driving component, so that the shielding component can form sun shield above the vehicles, in order to reduce direct sunlight to vehicles and reduce the temperature inside the car during outdoor use, prolong the service life of leather, wires and plastic products in the vehicle, and avoid the release of harmful gases from car seat and decorations inside the car at high temperatures, which will affect the health of drivers and passengers.

The material of shielding component 82 can be selected as flexible sunshade cloth. On the one hand, the sunshade cloth made of flexible material is easy to be rolled up in the shell 81, thereby reducing the occupied space. On the other hand, the lightweight design can reduce the weight of the device.

In an optional embodiment, the driving component includes the telescopic part, driving part and winding part. Telescopic part is connected with one end of the shielding component 82. The telescopic part comprises the first movable rod 83 and second movable rod 84, one end of the first movable rod 83 is connected with one end of the shielding component 82, one end of the second movable rod 84 is hinged with the other end of the first movable rod 83; Driving part, includes the motor 85. The connecting shaft 86 is provided on the end of the second movable rod 84 away from the hinge joint, which is sleeved with the first gear 87. The second gear 89 meshed with the first gear 87 is sleeved on the output shaft 88 of the motor 85; The winding part, is connected with the other end of the shielding component 82, used for rolling the shielding component 82.

In a preferable embodiment, light source could be provided on the side wall of the first movable rod 83 and/or the second movable rod 84, and the light source can be selected from LED light. Further, the light could be designed as strip light, which is placed on the bottom wall of the first movable rod 83 and/or the second movable rod 84. The distribution of the strip lights is the same as the length direction of the first movable rod 83 and/or the second movable rod 84. By this way, after the car sun shelter is fully unfolded, the light source can be turned on to provide illumination.

When the sun shading function of vehicles is required, the motor 85 will be started, and its output shaft 88 rotates clockwise, driving the second gear 89, meshed first gear 87, connecting shaft 86 to rotate in order, then the second movable rod 84 and the first movable rod 83 could be rotated to unfold the shielding component 82 out of the shell 81. When spread to the proper position, the motor 85 stops running. When the sun shading function is not required, the motor 85 rotates anticlockwise, and the shielding component 82 is folded into the shell 81, the principle of which is the same as that described above.

As for how to start and stop the operation of the motor 85, on the one hand, the start and stop of the motor 85 can be controlled by means of buttons, on the other hand, a controller can be provided to control the start and stop of the motor 85 by means of remote control. Further, the motor 85 is electrically connected to the controller, the remote control and the controller are wirelessly connected, such as bluetooth, 4G/5G and so on. The wirelessly connection belongs to the prior art, and the specific working principle could be found in the public technology, which will not be detailed in this invention.

The motor 85 can be stopped when the shielding component 82 being unfolded or folded to the proper position, which could be achieved by importing a corresponding program in the controller. This kind of control program also belongs to the prior art, and will not be detailed here.

In an optional embodiment, the winding part includes the winding drum 90, which is rotatably connected to the inner wall of the shell 81 through the winding sleeve 104; The winding sleeve 104 is connected to the winding drum 90 through the flat scroll spring provided inside, and the winding drum 90 is connected to one end of the shielding component 82.

Through the above arrangement, when the shielding component 82 spreads to the outside of the shell 81, the flat scroll spring will be tightened in the process; During the folding process of the shielding component 82, the flat scroll spring will gradually reset, driving the winding drum 90 to rotate, and rolling the shielding component 82.

In an optional embodiment, the shell 81 consists of the top arc cover plate 91, bottom connecting plate 92, and mounting plate 93 arranged on both sides between the top arc cover plate 91 and the bottom connecting plate 92; The gap between the top arc cover plate 91 and the bottom connecting plate 92 is defined as the second channel/second opening. In which, the arc-shaped cover plate can reduce the wind resistance as much as possible during vehicles running. It should be noted that, during the running of the vehicles, the fully automatic sun shelter is in the folded state.

In an optional embodiment, the outer surface of the component carrier is provided with photovoltaic panel and/or display screen. Preferably, photovoltaic panels and/or display screens are placed on both sides of the top arc cover plate 91.

In another optional embodiment, the driving component includes: telescopic part, driving part and winding part. Telescopic part, consist of the first movable rod 83 and second movable rod 84. One end of the first movable rod 83 is connected with one end of the shielding component 82, and one end of the second movable rod 84 is hinged with the other end of the first movable rod 83. The connecting block is hinged on the end of the first movable rod 83 away from the hinged connection with the second movable rod 84, and the movable plate 103 capable of opening or closing the second channel/second opening is connected to the aforementioned connecting block; Driving part, includes a motor 85. The connecting shaft 86 is provided on the end of the second movable rod 84 away from the hinge joint, which is sleeved with the first gear 87. The second gear 89 meshed with the first gear 87 is sleeved on the output shaft 88 of the motor 85. Winding part, is connected with the other end of the shielding component 82, used for rolling the shielding component. One end of the shielding component is fixedly connected to the movable plate 103, and the other end is fixedly connected to the winding part.

Based on the arrangement above, when the sun shelter is not in use, the second channel/the second opening is closed by the movable plate 103, which improves the sealing performance of the device when it is not in use, and prevents the interior of the device from rainwater and dust particles.

Preferably, the inner wall of the mounting plate 93 is provided with the limiting rod 99 that can be attaching connection with the shielding component 82. The limiting rod 99 plays the guiding and tensioning role for the shielding component 82, so that the shielding component 82 becomes more smooth when being rolled up.

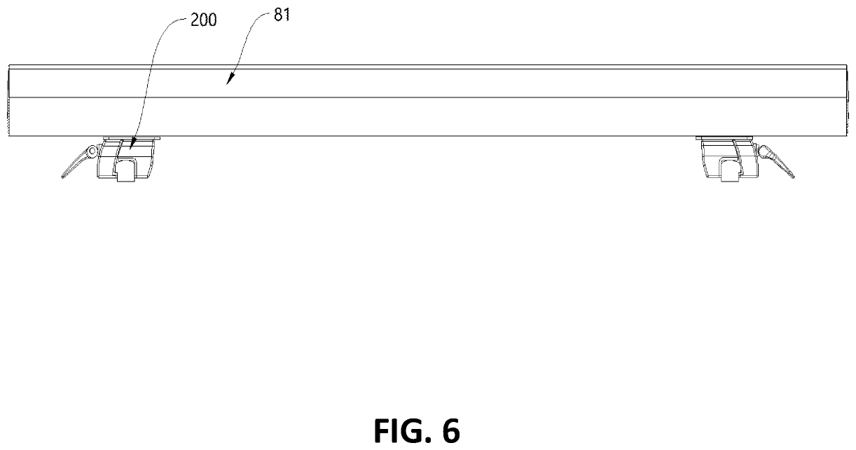

As shown in FIGS. 6-8, this car sun shelter further includes the mounting structure 200. The mounting structure 200 includes: the fixed clamp 94, first opening, nut 96, movable clamp 97, connecting rod 98, and limiting member 99. Fixed clamp 94 has accommodating space inside; First opening is provided on the side wall of the fixed clamp 94 and connected to the accommodating space; Nut 96 is placed in the accommodating space; Movable clamp 97 has the first channel penetrating through its two side walls; Connecting rod 98 is capable of entering into the accommodating space through the first channel/first opening, which has threads mating with the nut 96 on one end located in the accommodating space; Limiting member 99 is sleeved on the other end of the connecting rod 98, abutted with the movable clamp 97.

This mounting structure 200 can quickly adjust the tightness between the movable clamp 97 and the fixed clamp 94 by rotating the connecting rod; The operation is simple and convenient, and the disassembly and assembly process of the sun shelter is simplified, so that the scratches on the vehicles during disassembly and assembly can be avoided. In addition, this mounting structure can realize traceless installation.

In an optional embodiment, the fixed clamp 94 is equipped with the guide rail 101, and the movable clamp 97 is equipped with sliding bar 102 adapted to the guide rail 101. The above structure can further improve the stability of the device. In an optional embodiment, the handle 95 is provided on the end of the connecting rod 98 equipped with the limiting member 99, which makes the operation more labor-saving and convenient.

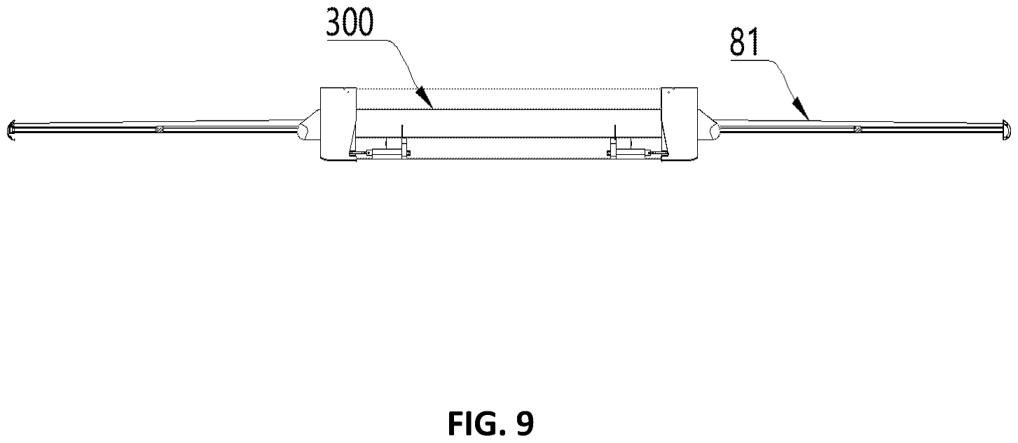

Secondly, the present invention discloses the car luggage rack. As shown in FIG. 9, the car luggage rack includes the luggage frame 300 and the car sun shelter described in the Embodiment 1. It should be noted that the second channel/second opening connected to the accommodating cavity is provided on one side wall of the shell 81 of the car sun shelters, that is, the shielding component 82 could only be unfolded from one side of this car sun shelter.

This car luggage rack not only has the basic functions of carrying goods, but also has the function of sun shading. At the same time, the luggage rack keeps the overall structure simple and compact under the premise of having multiple functions.

### Embodiment 2

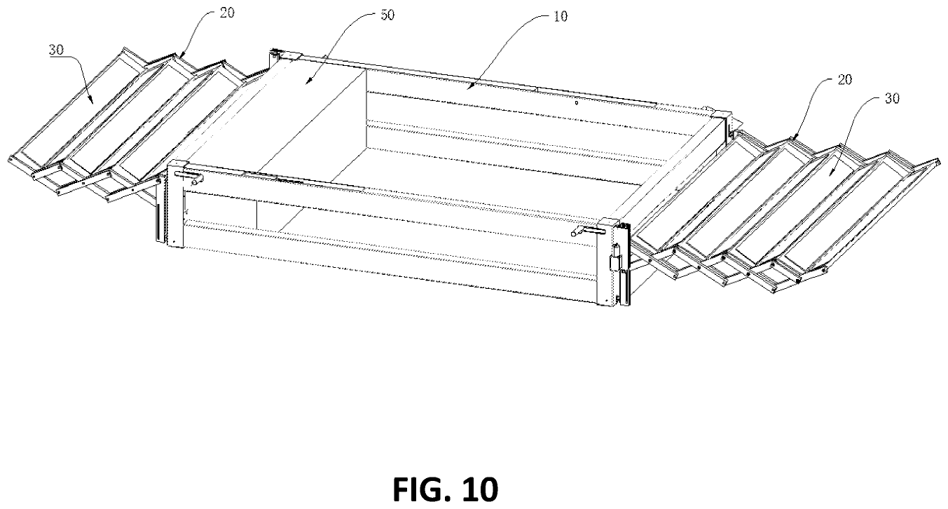

As shown in FIG. 10, the component carrier includes the frame 10, which comprises the wall portion and accommodating space formed by the wall portion, the wall portion is provided with at least one opening connected to the accommodating space. That is, the number of openings may be provided as one or as two or more, and the openings can be provided either at the top of the wall or at the side of the wall. In a preferable embodiment, the frame 10 is made of hollow aluminum alloy. Firstly, the aluminum alloy has lower density relative to other metals, the weight of the sun shelter can be reduced; Secondly, aluminum alloy also has good strength. Thirdly, the hollow structure of frame can provide space for components that need to be placed within the wall portion, such as blower, which will be described later.

In order to prevent the objects placed in the accommodating space from causing scratches on the top of the vehicles, the bottom of the wall portion could be designed as closed or reticular structure, or a layer of flexible material, such as cloth, rubber, etc., laid on the bottom and outer walls of the wall portion. In order to prevent the frame 10 from scratching the surface of the vehicles, a layer of flexible material, such as cloth, rubber, etc., could be provided on the outer surface of the frame 10 or the contact surface between the frame 10 and the vehicles. Alternatively, the frame 10 can be suspended in the air, that is, the frame 10 does not directly contact the surface of the vehicles, certain gap is provided between the frame 10 and the surface of the vehicles. Specifically, the frame 10 can be suspended by the support frame.

The door for covering the opening could be provided to form a closed accommodating space. This can prevent the items in the accommodation space from getting wet in rainy and snowy weather. At the same time, items can be locked in the accommodating space to prevent from falling during driving.

The telescopic frame 20 is provided on the frame 10, which can be fully folded or unfolded. The shield 30 is placed on the telescopic frame 20, which can be folded or unfolded along with the telescopic frame 20. The shield 30 and the telescopic frame 20 will form a shielding surface when the telescopic frame 20 is fully unfolded. The driving component is used to drive the telescopic frame 20 to be fully folded or unfolded, the number of telescopic frames 20 can be provided as required, such as one, two or more. In a preferable embodiment, two telescopic frames 20 are provided and respectively placed on opposite sides of the frame 10 as shown in FIG. 10. The telescopic frame 20 will be folded toward the frame 10, and will be unfolded away from the frame 10.

Based on the structure of the telescopic frame 20 and the shield 30, functions such as rain shielding and sun shading can be realized when the sun shelter is placed on the top of the vehicles. The material of shield 30 can be flexible sunshade cloth, or rigid plate structure, such as wooden board, steel plate, and the like.

Considering that the overall shape of most car on the market is curved structure, the upper surface of the vehicles mainly includes the hood, front windshield, vehicle top surface, rear windshield and trunk lid. Therefore, the space will be formed between the telescopic frame 20, front windshield and the hood after the telescopic frame 20 is unfolded horizontally. Based on the existence of this space, when the sun shelter realize the function of sun shading, although the telescopic frame 20 and the shield 30 will block most of the light, there will still be oblique sunlight breaking through the telescopic frame 20 and the shield 30 to form shadows on the vehicles.

In the same way, when the sun shelter plays other functions, such as shielding of rain, snow, or leaves, based on the existence of the space, although the telescopic frame 20 and the shield 30 could shield most of the rain, snow and leaves, there will still be leaves falling into the space or snow accumulating on the hood and front windshield.

In view of the above considerations, in an optional embodiment, an angle adjustment mechanism is provided to adjust the inclination of the telescopic frame 20. The angle adjustment here refers to adjusting the angle between the telescopic frame 20 and the horizontal plane. Based on the angle adjustment mechanism, the occupied space can be reduced as much as possible, the probability of snow or leaves falling into the space can be reduced, and the sunlight illuminating the windshield can be further reduced. The principle of realizing the angle adjustment will be introduced later.

Therefore, the sun shelter of the present invention also not only has the basic functions of carrying articles and expanding the load space of vehicles, but also has the functions of shielding from sunlight, rain and snow, etc.

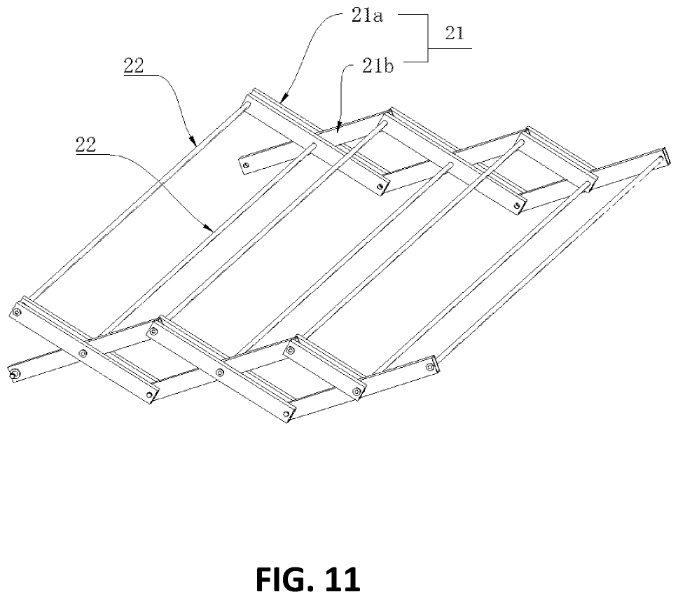

In a preferable embodiment, as shown in FIG. 11, the telescopic frame 20 includes a plurality of scissor-like elements that are linked and hinged to each other. In which, the scissor-like elements include the scissor arm group 21 and articulated arm 22. Two sets of scissor arm groups 21 are provided opposite to each other. The scissor arm groups 21 include the first scissor arms 21a and second scissor arms 21b, which are crossed and hinged with each other. Articulated arm 22, which is used to connect two sets of the scissor arm groups 21, as the carrier for installing the shield 30, and as the hinge shaft for realizing the hinge connection between the scissor-like elements, between the first scissor arms 21a and second scissor arms 21b. That is to say, the articulated arm 22 realizes the connection between the two sets of the scissor arm groups 21, and also realizes the hinge connection between the scissor-like elements, between the first scissor arms 21a and second scissor arms 21b. Through the arrangement above, the overall structure of the telescopic frame 20 could be simplified under the premise of realizing the required purpose, the production cost could be reduced by realizing multiple functions through one component.

There is no doubt that the car has become an indispensable means of transportation in modern society. Therefore, there is a broad market space for the sun shelter as car accessories. While bring convenience, cars also increase the energy consumption, so it is imperative to develop new energy vehicles that are energy-saving and environmentally friendly. New energy vehicles use unconventional fuels for vehicles as power sources, most of them on the market use electric drive or gasoline-electric hybrid drive. For pure electric vehicles, cruising range is a major pain point. On the one hand, the charging speed of electric vehicles is relatively slow compared to the refueling speed of traditional vehicles. On the other hand, the battery of electric vehicles is greatly affected by external environmental factors. For example, because the discharge capacity of the battery could be affected by temperature, the actual range of an electric vehicle in colder regions is often shorter than in warmer regions. This will make it difficult for drivers to estimate the real cruising range of the vehicles, and it is easy to run out of power before reaching the destination. If there is no charging place nearby, the only choice is to wait for rescue.

In order to solve this technical problem, the present invention provides an embodiment, which introduces the solar power generation panel or solar film on the basis of the embodiment. That is, the shield 30 could be selected from solar power generation panel or solar film. On the premise of not affecting the functions of shading from sunlight, rain and snow, it can also convert solar energy into electricity to provide electricity for electric vehicles. The electric energy generated by the solar power generation panel or the solar film can be directly connected to the battery carried by the vehicle itself. Alternatively, an external battery 50 could be installed, the electric energy generated by the solar power generation panel or the solar film can be stored in the battery 50 for driving vehicles or for other purpose. Further, the battery 50 could be externally connected with discharge port and charge port, the discharge port and the charge port could be installed on the frame 10. Based on the installation of the discharge interface, it can be used for supplying external power, for example, supplying power to devices such as mobile phones and cameras.

If the solar power generation panel is selected, it is required to be hinged with the articulated arm 22. The articulation can be realized by this structure: the ring or a cylinder could be placed on the edge of the solar power generation panel, and the ring or the cylinder could be sleeved on the articulated arm 22.

If the solar film is selected, it is not required to be hinged with the articulated arm 22, because the solar film has the ability to bend, but hinged with the articulated arm 22 is optional.

Under the action of the angle adjustment mechanism, the angle of the telescopic frame 20 can be adjusted, thereby the angle of the solar power generation panel or the solar film can be adjusted simultaneously. Finally, the absorption of solar energy could be improved, and the power generation efficiency could be improved.

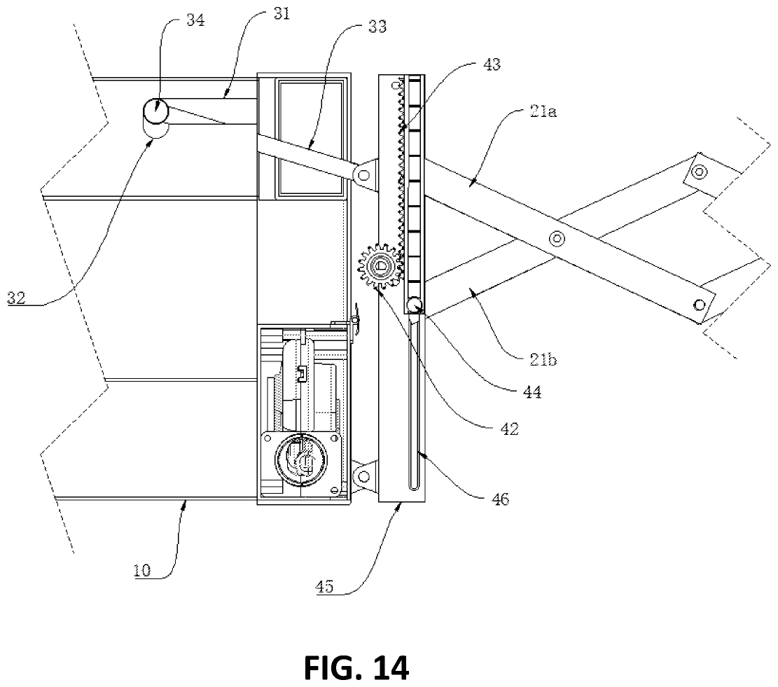

As shown in FIGS. 11 and 14, the driving component includes the motor 41, gears 42, gear rack 43 and mounting seat 45. Gears 42 are coaxially connected to the output shaft of the motor 41 and fixedly connected to the output shaft at least in the circumferential direction of the output shaft. Optionally, gears 42 are key connected with the output shaft. Gear rack 43, meshed with the gears 42, hinged with the first scissor arms 21a or the second scissor arms 21b of the scissor-like elements connected to the frame 10. Mounting seat 45, which is hinged with the frame 10, provided with the linear chute 46. The linear chute 46 is vertically distributed, provided with the hinge column 44 capable of sliding back and forth along the trajectory of the linear chute 46. The hinge column 44 is fixedly connected with the gear rack 43, the first scissor arms 21a or the second scissor arms 21b are hinged with the mounting seat 45 through the hinge column 44. The gears 42 could be driven to rotate by the motor 41, in order to drive the gear rack 43 to perform linear motion parallel to the linear chute 46, the scissor-like elements can be driven to perform scissor motion, then the telescopic frame 20 can be driven to be folded or unfolded.

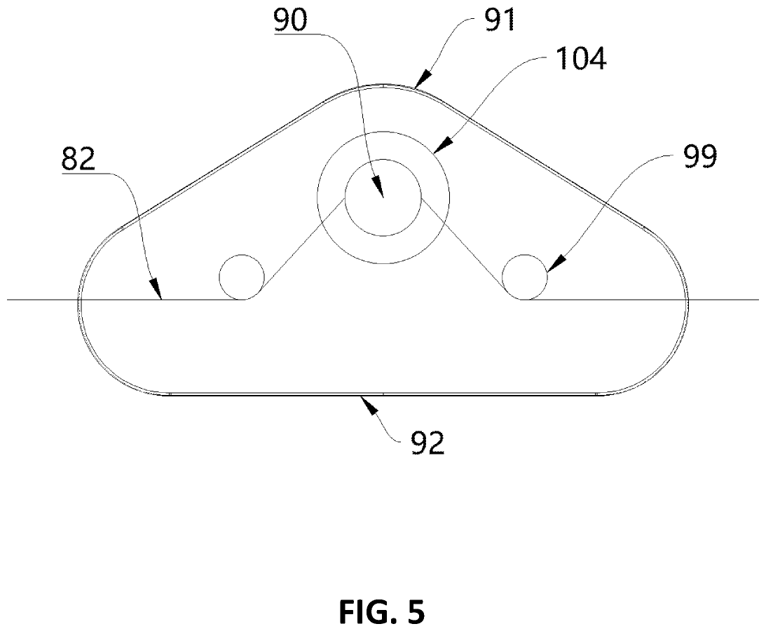

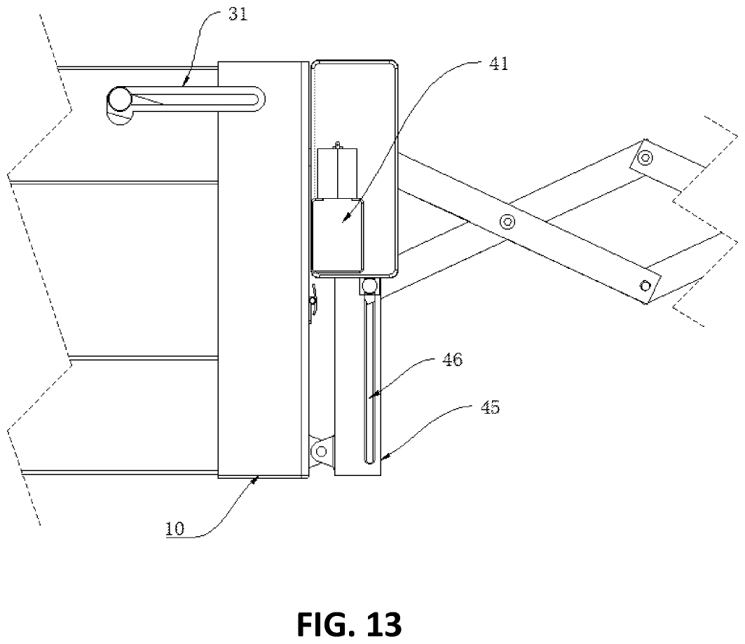

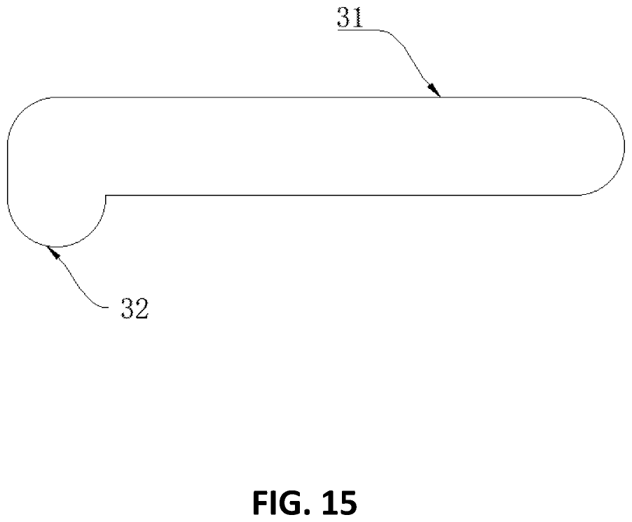

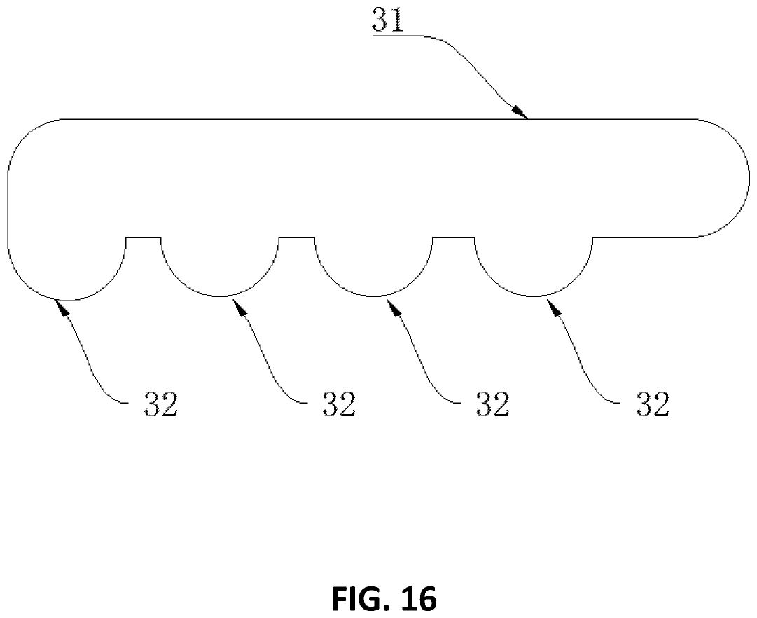

As mentioned above, the angle adjustment mechanism is used to adjust the included angle between the telescopic frame 20 and the horizontal plane. The specific structure of the angle adjustment mechanism will be specifically disclosed here. As shown in FIGS. 13-16, the angle adjustment mechanism includes the linear limiting groove 31, notches 32 and connecting rod 33. In which, the notch 32 is located on the side wall of the linear limiting groove 31 in the width direction. One end of the connecting rod 33 is hinged with the mounting seat 45, and the other end is provided with the sliding block 34. The sliding block 34 is located in the linear limit groove 31 and can be clamped in the notch 32. The number of the notches 32 can be one or more. More angles of telescopic frame 20 can be adjusted within the adjustable angle range with more notches 32. When a plurality of notches 32 are provided, the plurality of notches 32 should be placed at intervals along the length direction of the linear limiting groove 31. As shown in FIG. 5, when the sliding block 34 moves to the right, the telescopic frame 20 will be inclined downward.

Optionally, the notches 32 should be provided on the lower side wall of the linear limiting groove 31. Compared with provided on the upper side wall of the linear limiting groove 31, the sliding block 34 could be clamped more firmly. On this basis, optionally, the opening of the notches 32 can be slightly smaller than the diameter of the sliding block 34, the sliding block 34 could be less likely to slip out of the notches 32 when the sliding block 34 is snapped into the notches 32, which requires the sliding block 34 or the notches 32 having a certain deformability. Optionally, in order to further improve the firmness of the sliding block 34 being clamped in the notches 32, the non-slip coating could be applied to the surface of the notches 32 in contact with the connecting rod 33, or the surface of the notches 32/the surface of the sliding block 34 could be frosted directly. Further, the handle with anti-slip patterns could be provided on the sliding block 34, so as to facilitate the movement of the sliding block 34.

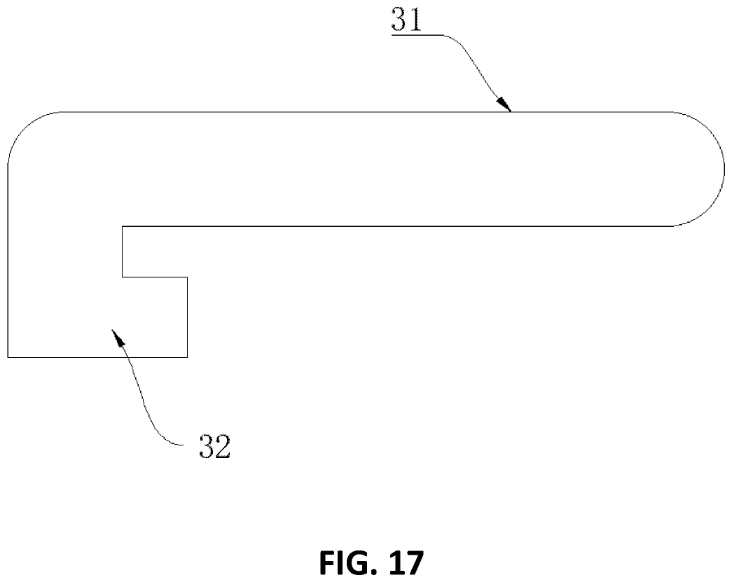

In a preferable embodiment, as shown in FIG. 17, the notch 32 is formed by extending downward from the lower side wall of the linear limiting groove 31 and then further extending toward the mounting seat 45, and finally the unidirectional limiting groove formed. It can be understood that the notch 32 includes two sections, define as section A and section B, wherein the section A is connected with the linear limit groove, the section B is connected with the notches in section A, and a certain angle will be formed between the notch in section A and section B. When the telescopic frame 20 is unfolded, the sliding block 34 is pulled to the right under the force of the notch 32, so when the sliding block 34 enters into the notch 32, it is more difficult to slip out from the notch 32.

In this embodiment, the adjustment of the telescopic frame 20 through the angle adjustment mechanism is manual, and the sliding block 34 needs to be manually adjusted to change the angle of the telescopic frame 20. It needs to be taken into account that some people may have difficulty in moving the sliding block 34 with low strength. At the same time, if the sun shelter is positioned on the roof of the vehicles, it is also difficult for some people to reach the sliding block 34.

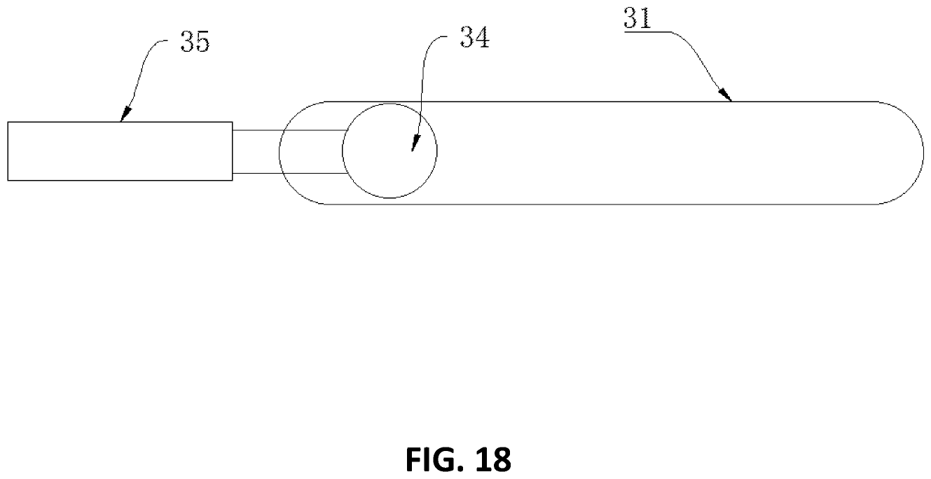

Therefore, the present invention provides another angle adjustment mechanism capable of adjusting the inclination of the telescopic frame 20 automatically. Specifically, the angle adjustment mechanism includes the linear limiting groove 31, connecting rod 33 and telescopic mechanism 35 as shown in FIG. 18. In which, one end of the connecting rod 33 is hinged with the mounting seat 45, and the other end is provided with the sliding block 34. The sliding block 34 is located in the linear limiting groove 31 and can slide back and forth along the length direction of the linear limiting groove 31. The telescopic direction of the telescopic mechanism 35 is parallel to the linear limiting groove 31, one end of the telescopic mechanism 35 is fixedly connected to the sliding block 34, and the other end is fixedly connected to the frame 10. The telescopic mechanism 35 can be selected from any one of the hydraulic cylinder, pneumatic cylinder and linear push rod. Further, the angle adjustment mechanism further includes controller electrically connected to the telescopic mechanism 35. The angle adjustment mechanism could adjust the position of the sliding block 34 through the extension or contraction of the telescopic mechanism 35, thereby adjusting the angle of the telescopic frame 20.

Another function of the sun shelter in the present invention is described below. The background is: In the flood season, the floods inundate the road, and it is difficult for the driver to see the markings and boundaries of the road. Therefore, it is possible to drive the car into the lake or river by mistake. After the falling into the water, the vehicles will sink to the bottom very quickly based on their own weight. The door will be difficult to open due to the pressure of the water, or the short circuit caused by river water, which will threaten the life and property safety of drivers and passengers.

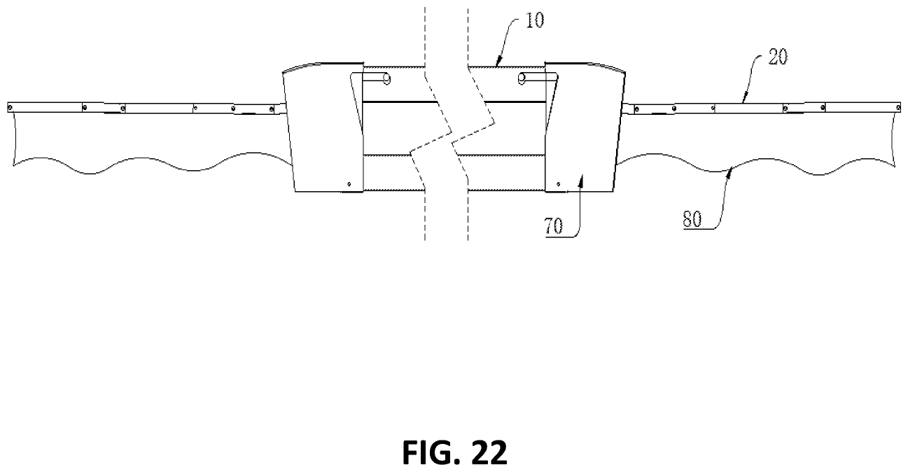

Therefore, the present invention provides an embodiment to solve the above technical problems. On the basis of the embodiments, as shown in FIG. 22, the sun shelter further includes the controller, airbag, inflation mechanism, water pressure sensor and pressure sensor. The controller here could be the same controller with the angle adjustment mechanism or additional controllers. However, it should be noted that if an additional controller is used, data between the controller here and the controller of the angle adjustment mechanism must be shared. Therefore, in order to reduce unnecessary troubles, simplify the overall structure, and reduce production costs, one controller should be better in a preferable embodiment.

Airbag is connected to the side of the frame 10 facing to the telescopic frame 20 and located below the telescopic frame 20. Inflation mechanism is electrically connected with the controller, for inflating the airbag. Water pressure sensor is used to detect the water pressure and transmit the signal of water pressure to the controller when the water pressure reaches the set threshold. Pressure sensor is electrically connected with the controller, which is used for detecting the pressure in the airbag. The purpose of arranging the airbag below the telescopic frame 20 is to provide a force point for the airbag to apply buoyancy to the vehicles. However, if the airbag is placed above the telescopic frame 20, the airbag will fold upwards when the vehicles fall and sink, which makes it difficult to provide buoyancy for the vehicles to float on the water.

In an embodiment, when the water pressure value acquired by the water pressure sensor reaches the set threshold value, signal will be transmitted to the controller, then the driving component will be controlled to unfold the telescopic frame 20, the inflation mechanism will be controlled to inflate the airbag by controller at the same time, which could provide buoyancy for the vehicles and prevent the vehicles from sinking to the bottom. When the pressure value obtained by the pressure sensor reaches the set value, the signal feedback will be transmitted to the controller, and the inflation mechanism will be controlled to stop inflating the airbag by controller, otherwise the inflation mechanism will burn out or the airbag will burst. When the pressure in the airbag is lower than the set value, the inflation mechanism will be controlled by controller to inflate the airbag again until the air pressure reaching the setting value. The controller could be a PLC controller independent of the vehicles, or directly connected to the ECU carried by the vehicle itself. It needs to be taken into account that when the vehicles fall into the water, the vehicles will stop running or the ECU may be damaged. Therefore, in a preferable embodiment, a PLC controller is independent of the vehicles. PLC control is a programmable controller, which can realize the above working process by programming in advance.

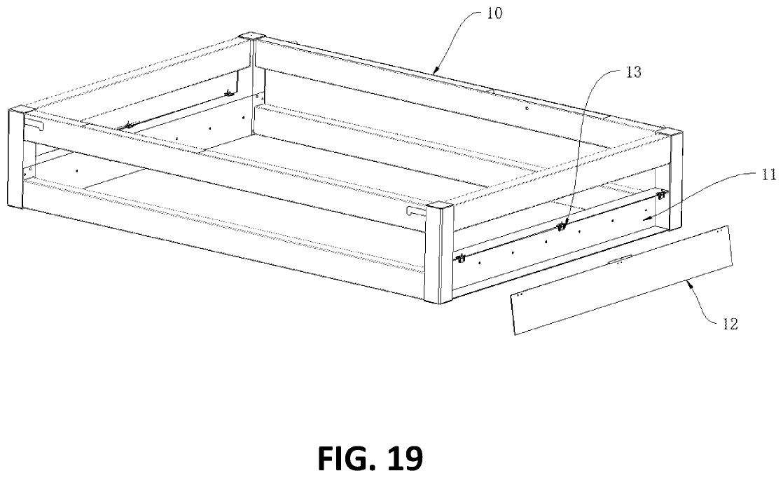

In an optional embodiment, as shown in FIG. 19, an airbag compartment 11 is provided on the side of the frame 10 facing to the telescopic frame 20, and the compartment opening is provided on the side of airbag compartment 11 facing the telescopic frame 20. The compartment opening is provided with the compartment door 12 for opening and closing the airbag compartment 11. Further, one end of the airbag is connected to the wall of the airbag compartment 11. Specifically, it can be connected by means of drawstrings, rivets, buttons, etc.

Based on the arrangement of the airbag compartment 11, the airbag can be stored in the airbag compartment 11 when not in use. On the one hand, the aesthetics of the sun shelter can be improved, and on the other hand, the airbag can be prevented from being exposed to the sun or being punctured, so as to prolong the service life of the airbag.

Further, a torsion spring 13 is provided at the hinge joint between the compartment door 12 and the compartment opening. Such structure may bring the compartment door 12 to have the tendency to close the compartment opening. Besides, there is no need to worry that the airbag is locked in the airbag compartment 11 and cannot be opened during actual use. In actual use, as shown in FIG. 19, after the aforementioned airbag 80 is inflated, the aforementioned compartment door 12 will be punched and open outward.

In an optional embodiment, the end of the airbag 80 is provided with a first electromagnet not shown in the drawings, and the end of the telescopic frame 20 is provided with a second electromagnet adapted to the first electromagnet not shown in the drawings. When the vehicles fall into the water, the first electromagnet and the second electromagnet are controlled to attract each other. In this way, when the telescopic frame 20 is unfolded, the airbag 80 will be stretched and expanded outward together, which facilitates the inflation of the airbag 80. In another optional embodiment, the end of the airbag 80 and the end of the telescopic frame 20 are fixedly connected instead of using the first electromagnet and the second electromagnet.

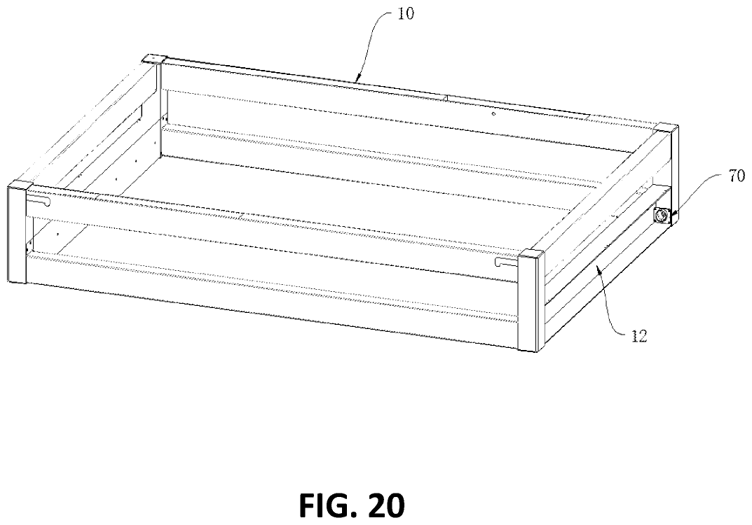

In an optional embodiment, as shown in FIG. 20, the inflation mechanism includes the blower 70. In order to prevent the blower from entering water and losing its ability to inflate the airbag, the blower 70 should be provided inside the frame 10. It should be noted that “inside the frame 10” here does not refer to the accommodating space defined and formed by the wall portion of the frame 10, it refers to the inside of the walls of the frame 10. The air outlet of the blower 70 is connected to the air inlet of the airbag. Therefore, at least one cavity for installing the aforementioned blower is required in the wall. As for the number of cavities, it depends on the number of blowers.

In general, the air inlet of the blower should be located above the airbag. By this way, the air inlet channel can be prevented from river water, the blower can be prevented from damaged and unable to play the role of inflating airbag after the vehicles fall into the water.

In order to prevent the blower from being directly exposed, an air inlet channel could be provided. The air inlet channel is placed in the wall, and the air inlet end of the air inlet channel is placed at the top of the frame 10 or the position close to the top. This could prevent the river water from entering into the air inlet channel after the vehicle falls into the water, causing the blower to be damaged and unable to play the role of inflating airbag.

It should be taken into consideration that when the airbag is not in use, the air inlet of the air inlet channel is still open. In the event of rain days, the rain may enter into the air inlet channel, causing the blower to be damaged when the airbag is required to be used.

Therefore, the plug can be provided to block the air inlet in rainy days, in order to prevent from rainwater when the airbag is not in use. However, there are certain drawbacks in this implementation. If the vehicles fall into the water in rainy weather or the user forgets to remove the plug, the blower will not work. Therefore, the user cannot be required to have this kind of subjective awareness at all times, that is, they can remember when to close the air inlet with the plug and when to remove the plug to open the air inlet each time.

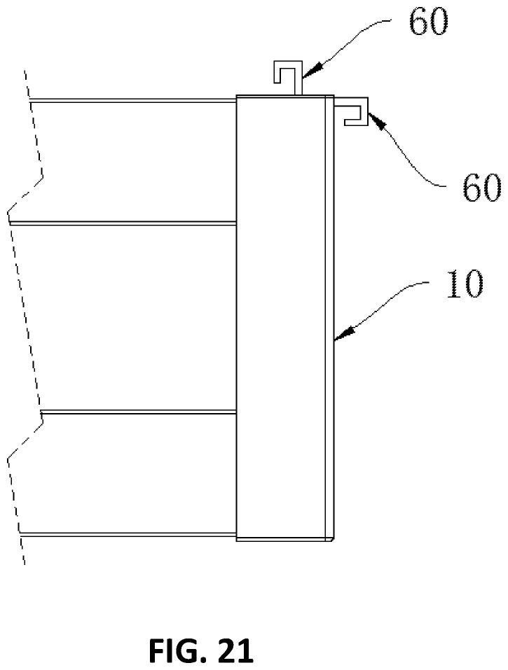

In a preferable embodiment, as shown in FIG. 21, an air inlet nozzle 60 is installed at the air inlet, and the air inlet end of the air inlet nozzle 60 should face to the frame 10. There is a certain gap between the air inlet end and the frame 10. The air inlet nozzle 60 can not only prevent rainwater from entering, but also prevent sundries from entering.

It should be noted that the number of blowers is not necessarily determined according to the number of airbags. One airbag may be equipped with one blower, or two or more blowers.

The aforementioned embodiments disclose various functions of the car sun shelter. However, it should be emphasized that the structures for realizing the above-mentioned multiple functions are not isolated from each other. On the contrary, part of the structure for realizing the above-mentioned multiple functions is shared. Therefore, the sun shelter of the present invention has the advantages of realizing various functions with simple and compact structure.

In a preferable embodiment, the openings are provided above and below the aforementioned frame 10 and the wall portion of the frame 10 can be sealing connected with the installation objects to form the space with the opening facing upwards and the other directions closed. The highest plane formed by the fully unfolded telescopic frame 20 is lower than the upper surface of the frame 10. The sealing connection between the frame 10 and the installation objects can be achieved by welding or setting a sealing strip.

Taking an example of installing the sun shelter on the top of the car, when the vehicles fall into the water, the telescopic frame 20 and the airbag will be opened. Since the highest plane formed by the fully unfolded telescopic frame 20 is lower than the upper surface of the frame 10, water cannot enter into the escape space. For cars with sunroofs, people can open the sunroof or break the sunroof through a window breaker, then wait for rescue or escape directly. Therefore, for the car with a sunroof, the sun shelter could be provided at the sunroof of the car and the lower opening of the frame 10 should cover the sunroof. In the existing technology, such car with escape function already exists. When the vehicles fall into the water, the sunroof will be automatically opened to prepare for the escape of driver and passengers. When the sun shelter of the present invention is applied to such vehicles, there is no need to use a window breaker to break the sunroof.

Thirdly, the present invention discloses the vehicles, which include the aforementioned sun shelter. The sun shelter is placed on the roof of the vehicles. Preferably, the sun shelter is placed at the sunroof of the vehicles and the lower opening of the frame 10 should cover the sunroof. In this way, the frame 10 and the car roof can form an escape with the opening at the top and closed at the bottom and around, so as to increase the escaping chances for the driver and passengers. This invention not only expands the accommodating space and the carrying capacity of the vehicle, but also increases the escape probability of the driver and passengers after the vehicles fall into the water.

Further, the water pressure sensor is arranged below the aforementioned frame 10. The purpose of placing the aforementioned water pressure sensor below the frame 10 is: We assume that in this case, the water pressure sensor is placed on the frame 10 or above the frame, when the vehicles fall into the water, only when the water is submerged above the frame 10, the pressure sensor could acquire the pressure signal and transmit the signal to the controller, then the controller could control the inflation mechanism to inflate the aforementioned airbag. At this time, the vehicle has been completely submerged, it is too late and there is no condition to inflate the airbag due to the air inlet has been submerged. Based on this consideration, the water pressure sensor should be arranged below the frame 10. The specific distance from the frame 10 needs to be calculated based on the speed of the vehicle sinking and the inflation speed of the aforementioned airbag. A person having ordinary skill in the art is capable of calculating appropriate values according to the description herein. However, it should be noted that the applicant cannot be deemed to have waived the inventiveness requirement of “placing the water pressure sensor below the frame 10”, because the numerical calculation is based on the embodiments of present invention.

In a preferable embodiment, the water pressure sensor is located in the engine compartment or the cab of the vehicles. This arrangement could prevent the water pressure sensor from receiving an invalid signal, thereby deploying the airbag when not needed. Specifically, if the water pressure sensor located outside the car in rainy days, the rain may hit the water pressure sensor, then the water pressure sensor may transmit the wrong signal to the controller, thereby deploying the airbag. However, the airbag does not need to be deployed at this time.

Due to the structure of the vehicle itself, the extent to which the airbag can be depressed at the front and rear ends of the vehicle is limited. For this purpose, the disc and second motor for driving the disc to rotate are fixedly provided on the bottom center of the frame 10. Based on the structure of the disc and the second motor, the frame 10 can be rotated until the frame 10 is perpendicular to the vehicles, so that the airbag could be pressed down on both sides of the vehicles instead of both ends. This can effectively increase the magnitude of the pressure of the airbag, providing greater buoyancy for the vehicles.

It should be stated that the disc and the second motor for driving the disc belong to the prior art, which will not be detailed here.

Fourthly, the present invention discloses the control method, including the aforementioned sun shelter. The control method specifically includes: when the pressure value acquired by the water pressure sensor reaches a threshold value, the airbag and the telescopic frame 20 could be opened. Further, the telescopic frame 20 is driven by the angle adjustment mechanism to press down the airbag, so that the vehicles can obtain greater buoyancy. It can be seen that the angle adjustment mechanism can not only play the role in adjusting the angle of the telescopic frame 20, but also play the role above-mentioned.

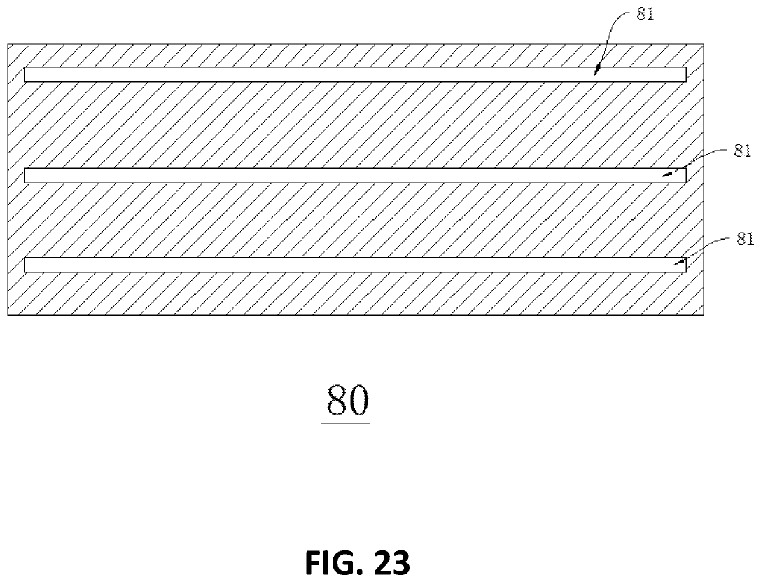

In an optional embodiment, the shape of the airbag 80 after deployment is preset. Preferably, the shape of the airbag 80 after deployment could be generally flat rectangular structure or cylinder structure, which is more likely to be pressed under the telescopic frame 20. Further, the airbag 80 is a non-closed plane after deployed. As shown in FIG. 23, there are gaps 81 penetrating the rectangular-like airbag 80 after deployed. Based on the arrangement of these gaps 81, it is easier for the the telescopic frame to press down the airbag 80 driven by angle adjustment mechanism.

The erroneous or invalid signal received by the water pressure sensor should be prevented, in order to avoid deploying the airbag when it is not necessary. Further, when the water pressure value acquired by the water pressure sensor reaches a threshold value and lasts for t time, it could be used as an effective signal for the controller, then control the aforementioned inflation mechanism to inflate the aforementioned airbag. This embodiment perfectly solves the problem of locating the pressure sensor outside the vehicles. Because the signal generated by the rain hitting is intermittent, the requirement of pressure duration time cannot be met. Therefore, the signal received by the controller is an invalid signal, and the inflating mechanism will not be controlled to inflate the airbag.

Fifthly, the present invention discloses the control method of the car sun shelter, including the aforementioned sun shelter. The control method specifically includes: when the pressure value obtained by the water pressure sensor reaches the threshold and lasts for t time, it is should be used as an effective signal for the controller, then control the aforementioned inflation mechanism to inflate the airbag. Then the frame 10 should be driven to rotate a angle in the horizontal direction, so that the airbag and the telescopic frame can have sufficient depression space. Preferably, the frame 10 should be driven to rotate a angle in the horizontal direction until the frame 10 is perpendicular to the length direction of the vehicle. Then the airbag and the telescopic frame 20 should be opened, and telescopic frame 20 should be driven to press down the airbag.

The preferred embodiments of the present invention disclosed above are provided only to help illustrate the present invention. The preferred embodiments do not exhaust all the details, nor do they limit the invention to the specific embodiments described. Obviously, many modifications and variations are possible in light of the contents of this specification. The present specification selects and specifically describes these embodiments in order to better explain the principles and practical applications of the present invention, so that those skilled in this field can well understand and utilize the present invention. The present invention is to be limited only by the claims and their full scope and equivalents.

What is claimed is:

1. The car sun shelter comprising a component carrier; a shielding component (82) installed on the component carrier; and a driving component for driving the shielding component (82) to be fully folded and unfolded to form the sun shield at predetermined position.

2. The car sun shelter according to claim 1, wherein the photovoltaic panel and/or display screen is provided on the outer surface of the component carrier.

3. The car sun shelter according to claim 1, wherein the component carrier includes the shell (81) including the shell wall and an accommodating cavity formed by the shell wall; and at least one side wall of the shell (81) is provided with the second channel/second opening connected to the accommodating cavity; wherein the driving component includes a telescopic part, connected with one end of the shielding component (82) and the telescopic part comprises the first movable rod (83) and second movable rod (84), one end of the first movable rod (83) is connected with one end of the shielding component (82) and one end of the second movable rod (84) is hinged with the other end of the first movable rod (83); a driving part, includes a motor (85); the connecting shaft (86) is provided on the end of the second movable rod (84) away from the hinge joint, the connecting shaft (86) is sleeved with the first gear (87); the second gear (89) meshed with the first gear (87) is sleeved on the output shaft (88) of the motor (85); and a winding part, is connected with the other end of the shielding component (82), used for rolling the shielding component (82).

4. The car sun shelter according to claim 1, wherein the component carrier includes the shell (81) that includes the shell wall and a accommodating cavity formed by the shell wall; at least one side wall of the shell (81) is provided with the second channel/second opening connected to the accommodating cavity, wherein the driving component includes a telescopic part, consist of the first movable rod (83) and second movable rod (84); one end of the first movable rod (83) is connected with one end of the shielding component (82), one end of the second movable rod (84) is hinged with the other end of the first movable rod (83); the connecting block is hinged on the end of the first movable rod (83) away from the hinged connection with the second movable rod (84), and the movable plate (103) capable of opening or closing the second channel/second opening is connected to the connecting block; a driving part, includes a motor (85); the connecting shaft (86) is provided on the end of the second movable rod (84) away from the hinge joint, the connecting shaft (86) is sleeved with the first gear (87); the second gear (89) meshed with the first gear (87) is sleeved on the output shaft (88) of the motor (85); a winding part, is connected with the other end of the shielding component, used for rolling the shielding component; one end of the shielding component is fixedly connected to the movable plate (103), and the other end is fixedly connected to the winding part.

5. The car sun shelter according to claim 3, wherein the winding part includes the winding drum (90), which is rotatably connected to the inner wall of the shell (81) through the winding sleeve (104); and the winding sleeve (104) is connected to the winding drum (90) through the flat scroll spring provided inside, and the winding drum (90) is connected to one end of the shielding component (82).

6. The car sun shelter according to claim 3, wherein the shell (81) includes the top arc cover plate (91), bottom connecting plate (92), and mounting plate (93) arranged on both sides between the top arc cover plate (91) and the bottom connecting plate (92); the gap between the top arc cover plate (91) and the bottom connecting plate (92) is defined as the second channel/second opening.

7. The car sun shelter according to claim 1, wherein the car sun shelter further includes an mounting structure (200) positioned at the bottom of the shell (81), and the mounting structure (200) includes: a fixed clamp (94), which has an accommodating space inside; a first opening, which is provided on the side wall of the fixed clamp (94) and connected to the accommodating space; a nut (96), placed in the accommodating space; a movable clamp (97), which has the first channel penetrating through its two side walls; a connecting rod (98), capable of entering into the accommodating space through the first channel/first opening, which has threads mating with the nut (96) on one end located in the accommodating space; and a limiting member (99), which is sleeved on the other end of the connecting rod (98), abutted with the movable clamp (97).

8. The car sun shelter according to claim 1, wherein the component carrier includes the frame (10), which comprises the wall portion and accommodating space formed by the wall portion; the wall portion is provided with at least one opening connected to the accommodating space; the shielding component includes the telescopic frame (20) and shield (30); the telescopic frame (20) is arranged on the frame (10), which can be fully folded or unfolded; the shield (30) is arranged on the telescopic frame (20), which can be fully folded or unfolded along with the telescopic frame (20); and the driving component can be used for driving the telescopic frame (20) to be fully folded or unfolded.

9. The car sun shelter according to claim 8, wherein the car sun shelter further includes an angle adjustment mechanism for adjusting the inclination of the telescopic frame (20), the angle adjustment mechanism comprises any one of the following structures: (a) the angle adjustment mechanism includes the linear limiting groove (31), at least one notch (32) and connecting rod (33); at least one of the notch (32) should be located on the side wall of the linear limiting groove (31) in the width direction; one end of the connecting rod (33) is hinged with the mounting seat (45), and the other end is provided with the sliding block (34); the sliding block (34) is located in the linear limit groove (31) and can be clamped in the notch (32); and (b) the angle adjustment mechanism includes the linear limiting groove (31), connecting rod (33) and telescopic mechanism (35); one end of the connecting rod (33) is hinged with the mounting seat (45), and the other end is provided with the sliding block (34); the sliding block (34) is located in the linear limiting groove (31) and can slide back and forth along the length direction of the linear limiting groove (31); the telescopic direction of the telescopic mechanism (35) is parallel to the linear limiting groove (31), one end of the telescopic mechanism (35) is fixedly connected to the sliding block (34), and the other end is fixedly connected to the frame (10).

10. The car sun shelter according to claim 9, wherein the notch (32) is formed by extending downward from the lower side wall of the linear limiting groove (31) and further extending toward the mounting seat (45).

11. The car sun shelter according to claim 8, wherein the telescopic frame (20) comprises a plurality of scissor-like elements that are linked and hinged with each other, and the scissor-like elements include: scissor arm groups (21), two sets of which are set opposite to each other; the scissor arm groups (21) include the first scissor arms (21a) and second scissor arms (21b), which are crossed and hinged with each other; articulated arm (22), which is used to connect two sets of the scissor arm groups (21), as the carrier for installing the shield (30), and as the hinge shaft for realizing the hinge connection between the scissor-like elements, between the first scissor arms (21a) and second scissor arms (21b).

12. The car sun shelter according to claim 8, wherein the shield (30) comprises solar power generation panel or solar film.

13. The car sun shelter according to claim 11, wherein the driving component includes: a motor (41); gears (42), which are coaxially connected to the output shaft of the motor (41) and fixedly connected to the output shaft at least in the circumferential direction of the output shaft; and a gear rack (43), which meshes with the gears (42), hinged with the first scissor arms (21a) or the second scissor arms (21b) of the scissor-like elements connected to the frame (10); a mounting seat (45), which is hinged with the frame (10), provided with the linear chute (46); The hinge column (44) capable of sliding back and forth along the trajectory of the linear chute (46) is provided within the linear chute (46); The hinge column (44) is fixedly connected with the gear rack (43), the first scissor arms (21a) or the second scissor arms (21b) are hinged with the mounting seat (45) through the hinge column (44); wherein the gears (42) can be driven to rotate by the motor (41), in order to drive the gear rack (43) to perform linear motion, then the scissor-like elements can be driven to perform scissor motion, so that the telescopic frame (20) can be driven to be fully folded or unfolded.

14. The car sun shelter according to claim 9, wherein the car sun shelter further comprises a controller; an airbag, which is connected to the side of the frame (10) facing to the telescopic frame (20) and located below the telescopic frame (20); an inflation mechanism, electrically connected with the controller, for inflating the airbag; a water pressure sensor, which is used to detect the water pressure and transmit the signal of water pressure to the controller when the water pressure reaches the set threshold; and a pressure sensor, electrically connected with the controller, which is used for detecting the pressure in the airbag.

15. The car sun shelter according to claim 14, wherein the openings are provided above and below the frame (10) and the wall portion of the frame (10) can be sealing connected with the installation objects to form the escape space with the opening facing upwards and the other directions closed.

16. The car sun shelter according to claim 15, wherein the bottom center of the frame (10) is fixedly provided with the disc and second motor for driving the disc to rotate.
